(19) United States
(12) Patent Application Publication
(10) Pub. No.: US 2011/0192864 A1
(43) Pub. Date: Aug. 11, 2011

(54) DISPENSING SYSTEM AND METHOD OF USE

(76) Inventors: Kenneth J. Rueschhoff, Wildwood, MO (US); Joseph C. Lott, Des Peres, MO (US)

(21) Appl. No.: 13/090,935

(22) Filed: Apr. 20, 2011

Related U.S. Application Data
(63) Continuation-in-part of application No. 12/147,757, filed on Jun. 27, 2008.
(60) Provisional application No. 60/946,713, filed on Jun. 27, 2007.

(51) Int. Cl. B67D 7/58

(52) U.S. Cl. 222/1; 222/135

(57) ABSTRACT

A system for dispensing polyurethane foam from DOT-39 compliant tank, includes a compressor having an outlet through which air is supplied, and a booster coupled to the outlet of the compressor. The booster provides a supply of compressed air at a pressure of between about 160 and about 200 pounds per square inch. At least two bladderless tanks having an internal volume sized less than 1,526 cubic inches to comply with DOT-39 specifications each contain a quantity of a polyurethane foam component that is sufficient to fill at least 70 percent of the internal volume of the bladderless tanks. A first valve on the bladderless tanks connects to the high pressure outlet of the booster. A second valve is adjacent the bottom of each bladderless tank. A dispenser for dispensing the polyurethane foam component is connected to the second valve on each of the bladderless tanks.

### CROSS-REFERENCE TO RELATED APPLICATION

This application is a continuation-in-part of U.S. patent application Ser. No. 12/147,757 filed on Jun. 27, 2008, which claims priority to U.S. Provisional Patent Application Ser. No. 60/946,713, filed Jun. 27, 2007. The entire disclosures of the above applications are incorporated herein by reference.

### BACKGROUND OF THE INVENTION

The present disclosure relates to systems for control of an appliance incorporating a flame, and more particularly relates to valve control of a fuel to such an appliance.

The present disclosure relates to dispensing systems and methods of dispensing materials, such as polyurethane foams.

Polyurethane foams have a wide variety of applications, but are particular useful in the construction industry for filling, sealing, insulating, and providing sound attenuation. For this reason, relatively large quantities of polyurethane foam must be transported to, and dispensed at, remote construction sites. Dispensing systems for dispensing polyurethane foams comprise either large refillable tank systems or small single use non-refillable tank systems.

Large refillable tank systems are too bulky and heavy to be portable to a worksite, and thus required long dispensing hoses that can extend to the worksite from a service truck containing the refillable tanks. Large refillable systems also involved loading foam product into large refillable tanks that require separate pressurizing tanks containing a pressurizing agent (e.g., nitrogen) to pressurize the refillable tanks as foam is dispensed, in order to ensure that foam product can be dispensed. However, such refillable systems often ended up with a significant amount of foam product left in the refillable tank, for lack of available pressurizing agent in the pressurizing tank. This resulted in an additional service trip to obtain another pressurizing tank, or the loss of the foam product remaining in the refillable tank that could no longer be used. Refillable tanks also required dip tubes, which were not able to draw all the remaining foam product from the bottom of the tank. As such, refillable systems could not guarantee that all of the foam product in the refillable tank could be used.

Small non-refillable systems comprise smaller single use non-refillable tanks that are subject to regulations prohibiting refilling of such tanks. In these systems, the foam is transported as components in disposable or single use, pressurized DOT-39 compliant tanks. DOT-39 (49 CFR §178.65) provides specifications for relatively light weight, non-refillable containers. These are desirable for this application because the containers can be made less expensively than refillable containers, and typically weigh less than refillable containers, which makes them easier to transport and handle. At the job site the tanks of the separate components are connected to a dispenser, and dispensed. After the materials are dispensed, the spent tanks are simply discarded. Small non-refillable tank systems are designed to operate without nitrogen pressurizing tanks, which makes them much more portable to a worksite.

However dispensing foam from the DOT-39 compliant containers is complicated by the fact that dispensing rates can diminish by as much as 50% or more as the contents of the tanks are used. Furthermore foam properties can vary as well, for example the density of the dispensed foam can vary by as much as 20% or more as the contents of the tank are used. Another difficulty with DOT-39 containers is their disposal. These containers can often only be filled to a maximum of about 60% due to the container volume required for propellant, thus a relatively large number of containers must be used for a given project, and once the foam has been dispensed the tanks must be disposed of. Disposal is further complicated by the fact that most of these tanks employ a dip tube system for extracting the contents of the tank. Because of manufacturing tolerances, the construction of these tanks and dip tube systems varies such that undispensed material is almost always left in the container. As such, non-refillable systems cannot guarantee that all of the foam product in the non-refillable tank can be dispensed or used. This is wasteful and it complicates recycling or other disposal methods of the spent containers. It is estimated that as much as 5% of the material is these containers may remain undispensed.

### SUMMARY

This disclosure relates to improved systems and methods for dispensing materials such as polyurethane foams from DOT-39 compliant containers.

According to one aspect, embodiments of the present disclosure provide a DOT-39 compliant system for dispensing material under pressure. The system preferably comprises a tank compliant with DOT-39 having at least two valves, and a charge of material to be dispensed. A pressure system is connected to at least one of the tank's valves for pressurizing or maintaining pressure in the tank. A dispenser is connected to another of the tank's valves for dispensing the material from the tank.

According to another aspect, embodiments of the present disclosure provide a DOT-39 compliant system for dispensing material formed from at least two components under pressure. The system comprises at least two tanks, each of which is compliant with DOT-39 and having at least two valves, and a charge of one of the components of the material to be dispensed. A pressure system is connected to at least one of each of the tank's valves for pressurizing or maintaining pressure in the tanks. A dispenser is connected to at least one of each of the tank's valves for mixing the components from the tank, and dispensing the material.

In the preferred embodiments of the systems in this disclosure, the tanks have at an upper valve adjacent the top of the tank, and a lower valve adjacent the bottom of the tank. The upper valve can be used for connection to a pressure system, the lower valve can be used for connection to dispensing system.

In still another aspect, embodiments of this disclosure provide a method for the pressure dispensing of a material at a remote location. This method can include transporting the material to be dispensed to the remote location in a tank compliant with DOT-39 and having at least two valves. A source of pressure is connected to at least one of valves of the tank. A dispenser is connected to at least one of the valves of the tank.

In still another aspect, embodiments of this disclosure provide a DOT-39 compliant tank of a polyurethane foam component in which the component fills at least 70% of the volume of the tank, and more preferably at least 90% of the volume of the tank. The tank preferably has at least two valves, and more preferably one of the valves is located in the upper portion of the tank, and one of the valves is located in the lower portion of the tank.

In still another aspect, embodiments of the disclosure provide a method of dispensing foam from DOT-39 compliant tanks at multiple locations. The DOT-39 compliant tanks are connected to a source of pressure to dispense foam at the first site. The DOT-39 compliant tanks are disconnected from the pressure source and transported to a second site. At the second site the DOT-39 complaint tanks are connected to a source of pressure to dispense foam at the second site.

The various embodiments of the present disclosure provides systems and methods for dispensing materials, and particularly polyurethane foam, from DOT-39. The various systems and methods reduce or eliminate some or all of the difficulties encountered with conventional DOT-39 compliant dispensing systems. The various systems and methods also reduce some of the difficulties encountered in disposing of spent DOT-39 containers, by reducing the number of such containers, and reducing the amounts of undispensed material left in the spent containers.

In one preferred embodiment, a DOT-39 compliant system for dispensing material formed from at least two components under pressure is provided. The system comprises a compressor having an outlet through which air is supplied, and a booster coupled to the outlet of the compressor. The booster is configured to compress the air output from the compressor to provide, via a high pressure outlet, a supply of compressed air at a pressure of between about 160 and about 200 pounds per square inch. The system includes at least two bladderless tanks, each of which have an internal volume that is sized less than 1,526 cubic inches to comply with DOT-39 specification for non-reusable, non-refillable cylinders. Inside each of the at least two bladderless tanks is disposed a quantity of a polyurethane foam component that is sufficient to fill at least 70 percent of the internal volume of the bladderless tanks. Each of the at least two bladderless tanks further include a first valve that is connected to the high pressure outlet of the booster for communicating the pressurized air into said bladderless tank to pressurize the bladderless tank, and a second valve adjacent the bottom of each bladderless tank, for connecting to a hose associated with a dispenser. The system further includes a dispenser for dispensing the polyurethane foam component from each of the at least two bladderless tanks. The dispenser is connected via at least two hoses to the second valve adjacent the bottom of each of the at least two bladderless tanks to enable dispensing of substantially all the polyurethane foam component disposed within each of the at least two bladderless tanks to minimize any remnant of polyurethane foam component left therein. The compressor and booster also provide a continuously replenished source of pressurized air for pressurizing the at least two bladderless tanks to enable substantially all polyurethane foam component within the bladderless tanks to be dispensed at constant pressure through the second valve adjacent the bottom of the bladderless tanks. These and other features and advantages will be apparent and pointed out hereinafter.

### BRIEF DESCRIPTION OF THE DRAWINGS

FIG. 1 is a diagram showing a conventional foam dispensing system employing conventional DOT-39 compliant component tanks;

FIG. 2 is a diagram of a preferred embodiment of a foam dispensing system in accordance with the principles of the present disclosure.

FIG. 3 is a perspective view of a second embodiment of a foam dispensing system including a compressor and booster, in accordance with the principles of the present disclosure;

FIG. 4 is a side view of the system in FIG. 3;

FIG. 5 is a front view of the system in FIG. 3;

FIG. 6 is a front perspective view of a control panel in FIG. 3;

FIG. 7 is a back perspective view of the control panel; and

FIG. 8 is a perspective view of the bladderless tank in FIG. 3.

### DETAILED DESCRIPTION

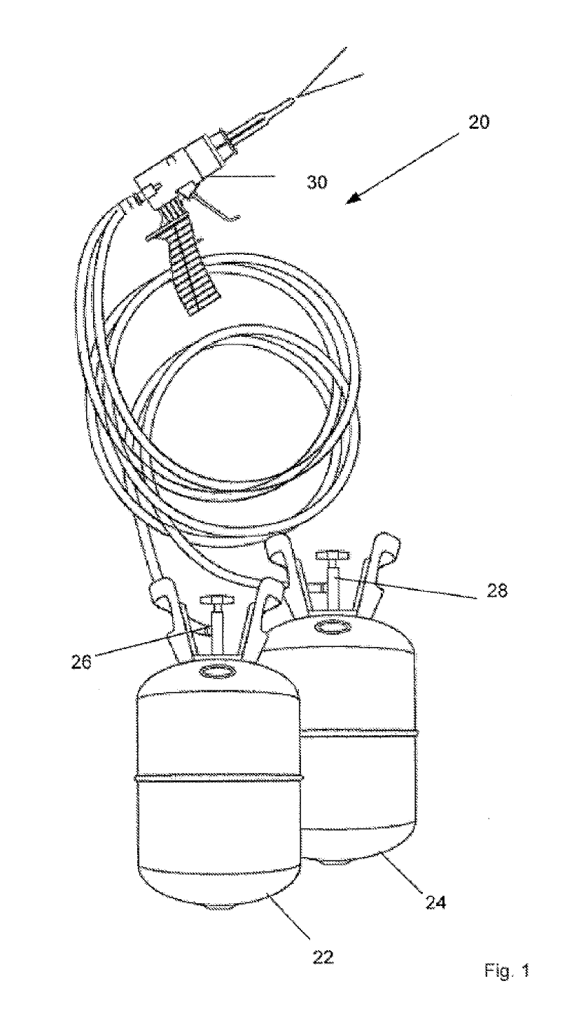

A conventional foam dispensing system employing conventional DOT-39 compliant tanks is indicated generally as 20 in FIG. 1. The system 20 comprises first and second containers 22 and 24 that are DOT-39 compliant. Each of the containers 22 and 24 holds a component of a polyurethane foam. Container 22 has a valve 26 for connecting the container to a dispenser 30. Similarly container 24 has a valve 28 for connecting the container to the dispenser 30. The dispenser 30 has controls (e.g. a trigger) for operating the dispenser to mix the components, and dispense foam. The dispensing rate from the system 20 varies with time, being greater when the containers are full, and diminishing as the containers empty. The properties of the foam being dispensed are also affected by the varying internal pressures and resultant dispensing rates during the dispensing process. When the contents of the tanks 22 and 24 are exhausted, the dispenser is disconnected from the tanks, and the tanks are disposed of. Because of the design of the tanks, there is typically residual material left in the tanks, which can complicate their disposal or recycling.

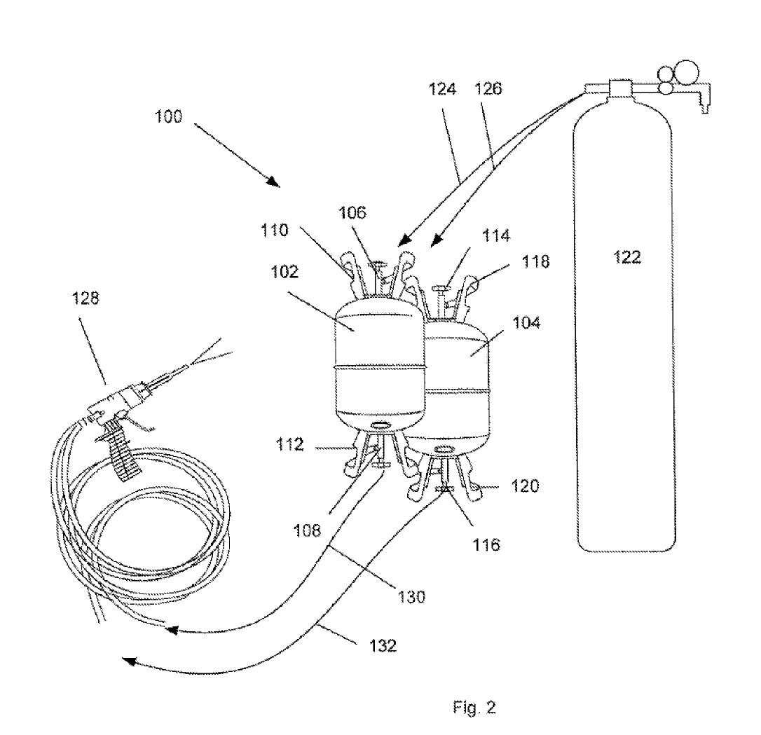

A preferred embodiment of a system for dispensing material in accordance with the principles of the present disclosure is indicated generally as 100 in FIG. 2. The system 100 comprises first and second containers 102 and 104 that are DOT-39 compliant. Each of the containers 102 and 104 holds a component of a polyurethane foam. Container 102 has at least two valve 106 and 108. Valve 106 is preferably located in the upper portion of the container 102 (most preferably at the top), and may be surrounded by a protective cage 110. Valve 108 is preferably located in the lower portion of the container 102 (most preferably at the bottom), and may be surrounded by a protective cage 112, that also forms a stand for the container. Similarly, container 104 has at least two valves 114 and 116. Valve 114 is preferably located in the upper portion of the container 104 (most preferably at the top), and may be surrounded by a protective cage 118. Valve 116 is preferably located in the lower portion of the container 104 (most preferably at the bottom), and may be surrounded by a protective cage 120 that also forms a stand for the container.

Because containers 102 and 104 each have at least two valves, each can be connected to a source of pressure without interfering with the ability to access the material in the container. Thus, as shown, each of the containers 102 and 104 is connected to a source of pressure, such as a regulated gas cylinder 122, via hoses 124 and 126 connected to valves 106 and 114, respectively. Of course some other source of pressure could be used, such a compressor. Furthermore, while the source of pressure is preferably at a constant pressure, this is not critical. In the preferred embodiment, where the source of pressure is a source of constant pressure, the containers 102 and 104 will be maintained at a relatively constant pressure, which improves dispensing time, and the consistency of the foam being dispensed.

The connection to an external source of pressure also means that the containers 102 and 104 are not dependent solely upon their internal pressure to dispense their contents. This means that for a given size container, more of the volume can be used for the material to be dispensed, and less of the volume is used for propellant. Furthermore, a more consistent pressurization results in a more consistent dispensing rate, which also means more consistent properties (such as density) of the dispensed foam.

A dispenser 128 can be connected to the containers 102 and 104 via hoses 130 and 132 connected to valves 108 and 116, respectively. The connection to the containers 102 and 104 from valves at the bottom means that the material can be more completely drained from the containers. This means that more of the material loaded into the containers is available for use, and that there will be less remnants in the container to impair recycling of the containers.

The system of the present disclosure can be used to dispense foams of any density, from 0.5 pounds per cubic foot to about 6 pounds per cubic foot.

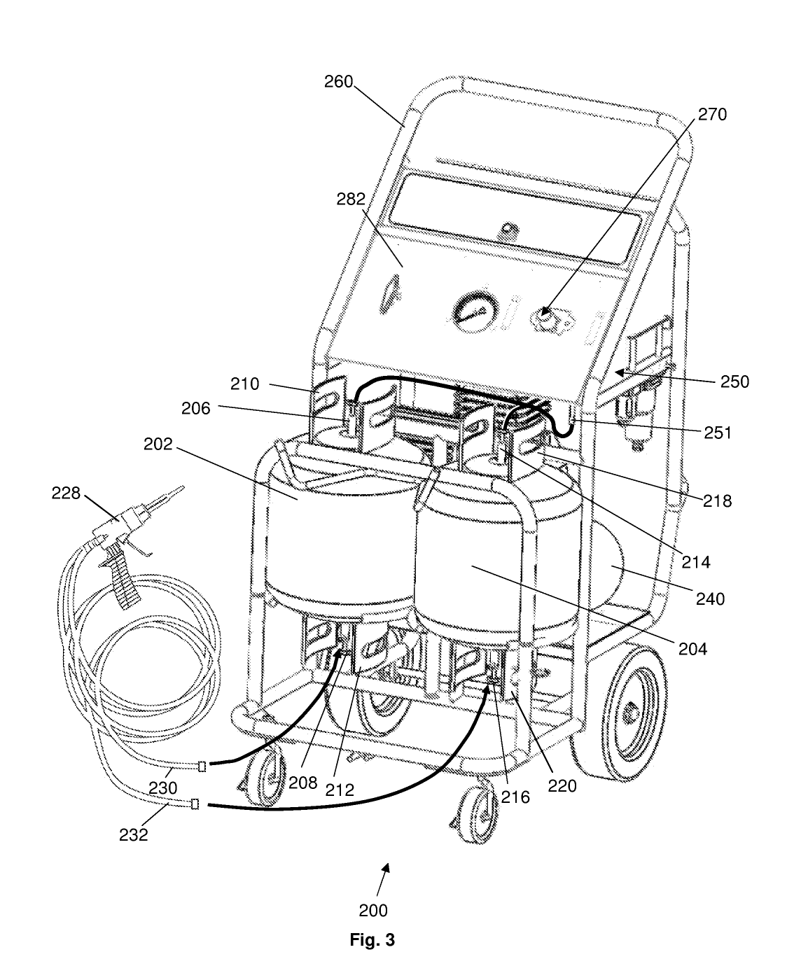

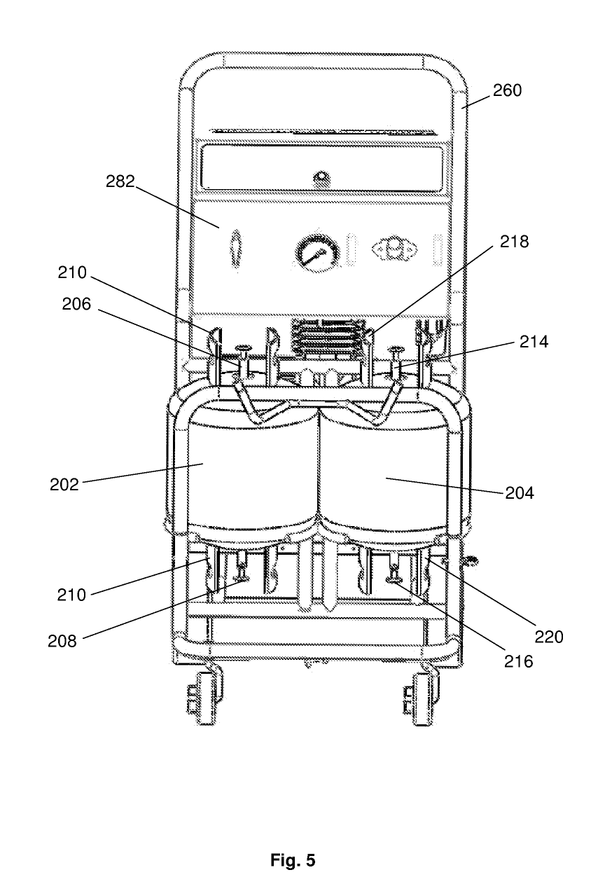

Referring to FIGS. 3-5, a second preferred embodiment of a system for dispensing material in accordance with the principles of the present disclosure is indicated generally as 200. In the second embodiment, the system 200 also comprises a source of pressure, which in this case is in the form of a compressor 240 and a booster 250 that draw from the surrounding air to provide a supply of compressed air for use in dispensing operation. The booster 250 (disposed within a control panel 282) is coupled to the outlet 242 of the compressor 240 to provide for a supply of compressed air to at least two tanks, as explained below.

As shown in FIGS. 3-5, the system 200 further comprises a first bladderless tank 202 and a second bladderless tank 204, which each have an internal volume that is sized less than 1,526 cubic inches to comply with DOT-39 specifications for non-reusable, non-refillable cylinders. Within the internal volume of each bladderless tank 202, 204 is disposed a quantity of polyurethane foam component material that is sufficient to fill at least 70 percent of the internal volume of the bladderless tanks 202, 204. Specifically, each of the bladderless tanks 202 and 204 holds separate components of a polyurethane foam. The first bladderless tank 202 holds a first component of a polyurethane foam, and the second bladderless tank 204 holds a second component of a polyurethane foam, where the components react when combined to form the end polyurethane foam product.

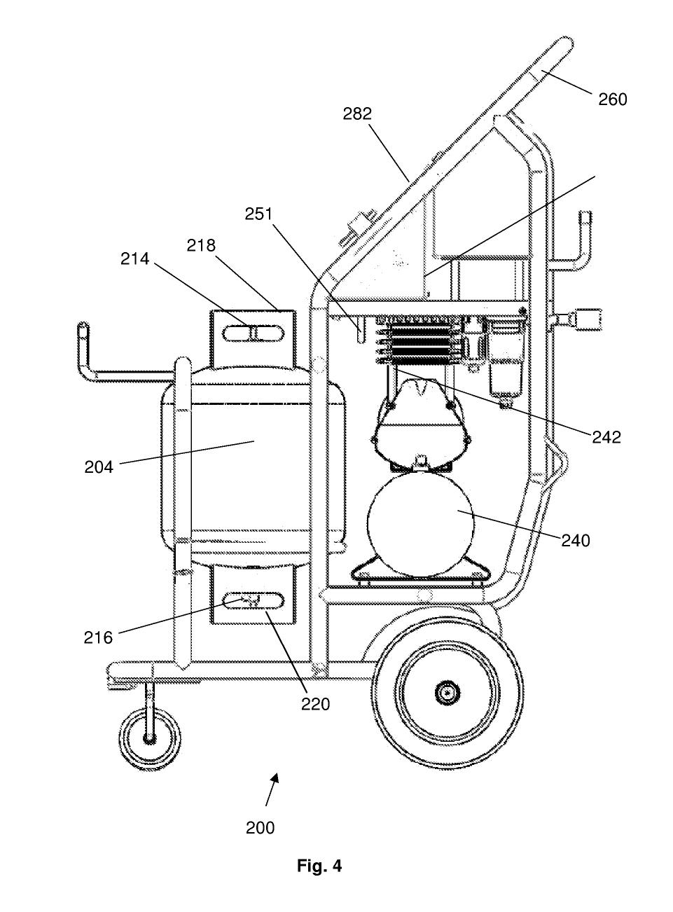

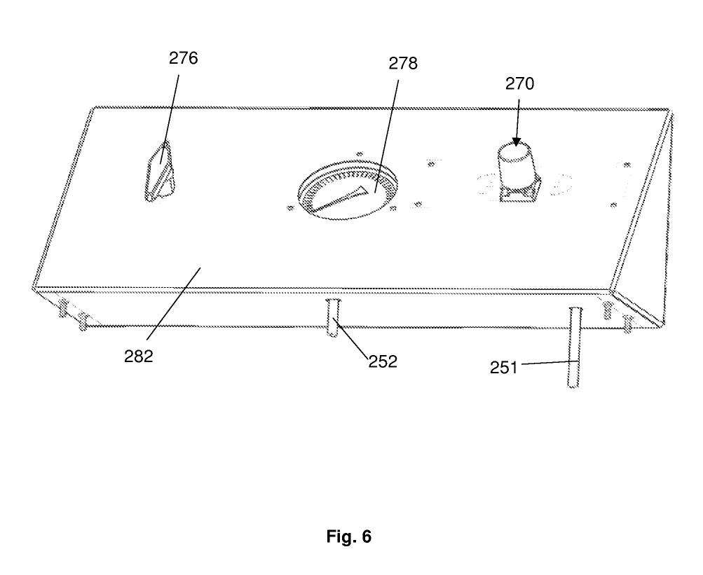

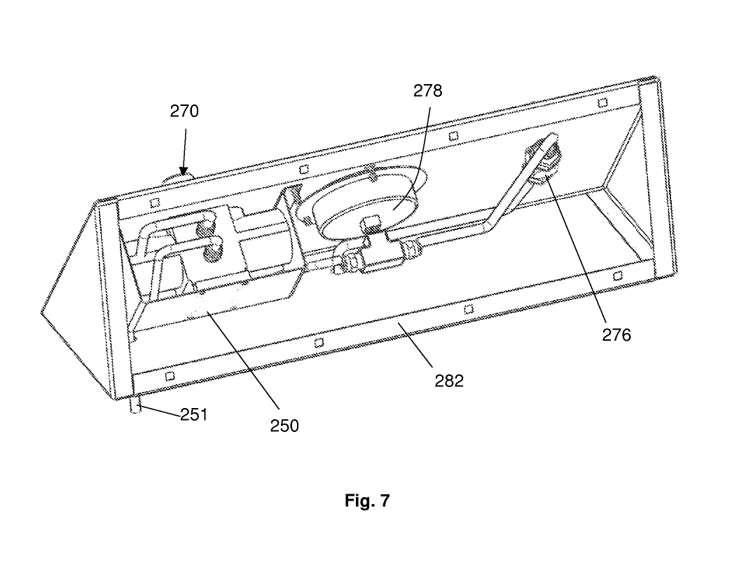

Referring to FIGS. 6-7, the booster 250 is disposed within a control panel 282, and includes an inlet 251 as shown in FIG. 6, which is coupled to the outlet 242 of the compressor 240 (FIG. 4). The booster 250 is configured to compress the air output from the compressor 240 to provide, via a high pressure outlet 252, a supply of compressed air at a pressure of between about 160 and about 200 pounds per square inch. The booster 250 may further include a regulator 270 for adjusting and regulating the pressure level of the output of the booster 250. Also shown is a T-handle 276 for opening and shutting off the supply of pressurized air, as well as a gauge 278 indicating the pressure provided by the compressor 240 and booster 250.

Referring to FIGS. 3-5, a first valve is disposed on each bladderless tank 202, 204, and is connected to the high pressure outlet 252 of the booster 250 for communicating the pressurized air into the bladderless tanks 202, 204 to pressurize the bladderless tanks 202, 204. A second valve is disposed on each bladderless tank 202, 204 adjacent the bottom of the bladderless tanks 202, 204, which is to be connected via a hose to a dispenser. Accordingly, bladderless tank 202 has two valve 206 and 208, and bladderless tank 204 has two valve 214 and 216

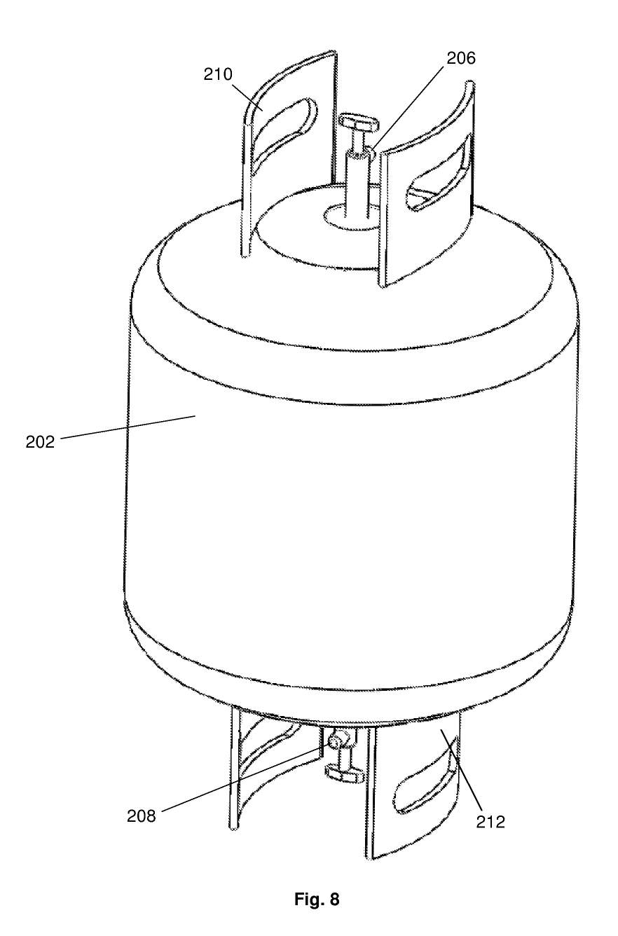

Referring to FIG. 8, the bladderless tank 202 and first and second valves 206 and 208 are shown in more detail. Valve 206 is preferably located in the upper portion of the bladderless tank 202 (most preferably at the top), and may be surrounded by a protective cage 210. Valve 208 is preferably located in the lower portion of the bladderless tank 202 (most preferably at the bottom), and may be surrounded by a protective cage 212, that also forms a stand for the bladderless tank 202. Similarly, the second bladderless tank 204 shown in FIGS. 3-5 has at least two valves 214 and 216. Valve 214 is preferably located in the upper portion of the bladderless tank 204 (most preferably at the top), and may be surrounded by a protective cage 218. Valve 216 is preferably located in the lower portion of the bladderless tank 204 (most preferably at the bottom), and may be surrounded by a protective cage 220 that also forms a stand for the bladderless tank 204.

Because the bladderless tanks 202, 204 each have at least two valves, each can be connected to a source of pressure without interfering with the ability to access the material in the bladderless tanks 202, 204. Thus, as shown in FIGS. 3-5, each of the bladderless tanks 202, 204 are connected to a source of pressure in the form of a compressor 240 and booster 250. The high pressure outlet 252 of the booster 250 provides a continuously replenished source of pressurized air, which means that the bladderless tanks 202, 204 are not dependent solely upon their internal pressure to dispense their contents. This means that for a limited size of the bladderless tanks 202, 204, more of the internal volume can be used for the foam components to be dispensed, and less of the volume must be dedicated for holding a propellant. The also enables substantially all of the polyurethane foam component within the bladderless tanks 202, 204 to be dispensed at constant pressure through the second valve adjacent the bottom of each bladderless tank 202, 204. Furthermore, a more consistent pressurization in the bladderless tanks 202, 204 results in a more consistent dispensing rate, which also means more consistent properties (such as density) of the foam that is dispensed, as explained below.

The system 200 further includes a dispenser 228 for dispensing the polyurethane foam component material from each bladderless tank 202, 204. The dispenser 228 can be connected to the each bladderless tank 202, 204 via hoses 230 and 232 connected to valves 208 and 216, respectively. The connection to the bladderless tanks 202, 204 from the second valves at the bottom means that the component material can be more completely drained from the bladderless tanks 202, 204. Thus, the dispenser 228 is connected via hoses 230 and 232 to the second valve on each bladderless tank 202, 204 such that the connection of the dispenser 228 to the second valve adjacent the bottom permits dispensing of substantially all the polyurethane foam component disposed within each bladderless tank 202, 204, to minimize any remnant of polyurethane foam component left within the bladderless tank. This means that more of the component material loaded into each bladderless tank 202, 204 is available for use, and that there will be less remnants in the bladderless tanks 202, 204 to impair recycling of the bladderless tanks 202, 204.

The system 200 further includes a cart 260 on which the compressor 240, the booster 250, and the bladderless tanks 202, 204 are disposed. The combined weight of the cart 260, the compressor 240, the booster 250, the bladderless tanks 202, 204 and first and second valves thereon, and the polyurethane foam component therein, and the dispenser 228, is less than about 600 pounds, such that the system 200 may be portably moved by a single person to a worksite.

As shown in FIG. 7, the booster 250 may further include a regulator 270 (disposed within the control panel 282) for regulating the pressurized air at the high pressure outlet 252 of the booster 250 to provide an operating pressure range that is within 10 pounds per square inch and is adjustable between upper and lower limits of 160 and 200 pounds per square inch. The booster 250 and regulator 270 provide for adjustment of pressure level that enables control over the density and dispensing rate of polyurethane foam component to allow for various conditions.

In the above described system, the desired operating pressure level is preferably in the range of between about 170 and about 190 pounds per square inch. The second valve on each bladderless tank 202, 204 is positioned near the bottom such that less than about 1% of the initial quantity of polyurethane foam component remains when the dispenser 228 fully dispenses the polyurethane foam component. In some constructions, the first valve may be positioned above the second valve, where the first and second valves are both connected to the bladderless tank at a single location.

According to another aspect of the present disclosure, a method for pressure dispensing of a polyurethane foam component material at a remote location is provided. The method comprises filling a bladderless tank (having an internal volume that is sized less than 1,526 cubic inches to comply with DOT 39 specifications for non-refillable cylinders) with a quantity of polyurethane foam component material that is sufficient to fill at least 70 percent of the internal volume of the bladderless tank, and transporting the bladderless tank and quantity of polyurethane foam component material to a remote worksite location. The method further includes the step of generating a supply of compressed air at a pressure of between about 160 and 200 pounds per square inch, via a booster coupled to the outlet of a compressor, which is communicated to a first valve disposed in the bladderless tank to pressurize the bladderless tank. The method also includes connecting a dispenser via a hose to a second valve adjacent the bottom of the bladderless tank, and dispensing the polyurethane foam component material from the bladderless tank that is supplied with pressurized air such that the polyurethane foam component material is dispensed under constant pressure. In the above described method, the polyurethane foam component is dispensed while the compressor and booster provide a continuously replenished supply of compressed air to pressurize the bladderless tank, to enable substantially all polyurethane foam component disposed within the bladderless tank to be dispensed at constant pressure through the second valve adjacent the bottom of the bladderless tank, to thereby minimize any remnant of polyurethane foam component left within the tank.

The method may further comprise the intermediate step of regulating the pressurized air that is communicated to a first valve to provide an operating pressure range within 10 pounds per square inch that is adjustable between about 160 and 200 pounds per square inch. The method may also include the intermediate step of moving the compressor, the booster, the first and second valves, the bladderless tank and polyurethane foam component therein, and the dispenser to a desired location at a worksite. The step of filling the bladderless tanks may comprise filling the bladderless tank to at least about 90 percent of the internal volume of the bladderless tank. Similarly, the step of dispensing the components may comprise dispensing at least 99 per cent of the initial of polyurethane foam component material, wherein the density of the dispensed polyurethane foam at the start of dispensing and the density of the dispensed polyurethane foam at the completion of dispensing varies by no more than about 8 percent when no other system changes are imposed. During the dispensing step, the generating of compressed air that is communicated to the bladderless tanks enables the dispensing rate at the start of dispensing and the dispensing rate at the completion of dispensing to vary by no more than about 15 percent when no other system changes are imposed.

### ADVANTAGES OF THE PREFERRED EMBODIMENT

By providing a system 200 with at least two bladderless tanks 202, 204 and a pressure source for providing a continuously replenished source of pressurized air, the system 200 permits delivery of more polyurethane foam to a worksite since more of the internal volume of the bladderless tanks 202, 204 can be used for holding polyurethane foam component, and the remaining internal volume can be filled with pressurized air as component is dispensed from the bladderless tanks. Furthermore, the continuous pressurizing of the tanks provides a more consistent pressure that results in a more consistent dispensing rate, which also means more consistent properties (such as density) of the dispensed foam. The continuous supply of air further avoids the time and expense associated with nitrogen pressurizing tanks utilized in large refillable tank systems.

Additionally, the dispenser being connected via at least two hoses to the second valve adjacent the bottom of each of the at least two bladderless tanks to enable dispensing of substantially all the polyurethane foam component disposed within each of the at least two bladderless tanks, to minimize any remnant of polyurethane foam component left therein.

Furthermore, the compressor together with the booster and regulator provide a continuously replenished source of pressurized air for pressurizing the first and second bladderless tanks to an adjustable pressure level between about 160 and about 200 pounds per square inch, to thereby provide control over the dispensing rate and density of polyurethane foam that is dispensed at the worksite. The continuous supply of pressurized air also enables substantially all of the first and second polyurethane foam component within the first and second bladderless tanks to be evenly dispensed at constant pressure from the first and second bladderless tanks, so as to minimize any remnant of polyurethane foam components in either of the first and second bladderless tanks.

Other advantages provided the above preferred embodiment of a system for dispensing a polyurethane foam component is that the system may be easily transported by one person due to the compact size of bladderless tanks 202, 204 and dispensing system 200, as compared to other refillable tank systems that require large nitrogen supply tanks for supplying a pressurized agent. With the dispensing system 200, the entire dispensing cart is mobile and able to easily transport the foam component dispensing system to and around a jobsite, including around standard doorways and hallways. In the above dispensing system 200, the working pressurized agent is never depleted, which often is a negative issue for users of refillable dispensing systems that utilize nitrogen-filled pressurized gas cylinders. Furthermore, since the above system 200 enables higher fill percentages of polyurethane foam component, less bladderless tanks would need to be disposed, which would lessen the environmental impact caused by disposal of the bladderless tanks. Additionally, the above system provides for nearly complete evacuation of polyurethane foam components or other chemicals within the tanks, as a result of even pressurization of the at least two bladderless tanks and the second valves at the bottom of the bladderless tanks (which enable use of substantially all component within the bladderless tanks). Also, the lack of a dip tube within the bladderless tanks improves the likelihood of opportunity to recycle the bladderless tanks rather than sending them to a land fill.

While the preferred embodiment of the system is particularly adapted for use in transporting and dispensing two part urethane foams, the present disclosure is not so limited and can be used in delivering other multipart substances, such as epoxies, polyurea, polyester styrene and silicones, and even single part substances such as paints/coatings, adhesives and sealants.

What is claimed is:

1. A DOT-39 compliant dispensing system for dispensing a polyurethane foam component under constant pressure, the system comprising:
a compressor having an outlet through which air is supplied;
a booster coupled to the outlet of the compressor, being configured to compress the air output from the compressor to provide, via a high pressure outlet, a supply of compressed air at a pressure of between about 160 and about 200 pounds per square inch;
at least two bladderless tanks, each of which have an internal volume that is sized less than 1,526 cubic inches to comply with DOT-39 specification for non-reusable, non-refillable cylinders, in which is disposed a quantity of a polyurethane foam component that is sufficient to fill at least 70 percent of the internal volume of the bladderless tanks, each which further include
a first valve that is connected to the high pressure outlet of the booster for communicating the pressurized air into said bladderless tank to pressurize the bladderless tank, and
a second valve adjacent the bottom of each bladderless tank, for connecting to a hose associated with a dispenser; and
a dispenser for dispensing the polyurethane foam component from each of the at least two bladderless tanks, the dispenser being connected via at least two hoses to the second valve adjacent the bottom of each of the at least two bladderless tanks to enable dispensing of substantially all the polyurethane foam component disposed within each of the at least two bladderless tanks, to minimize any remnant of polyurethane foam component left therein;
wherein the compressor and booster provide a continuously replenished source of pressurized air for pressurizing the at least two bladderless tanks to enable substantially all polyurethane foam component within the bladderless tanks to be dispensed at constant pressure through the second valve adjacent the bottom of the bladderless tanks.

2. The system according to claim 1, further comprising a wheeled cart on which the compressor, booster, and at least two bladderless tanks are disposed.

3. The system according to claim 2, wherein the combined weight of the cart, the compressor, the booster, the at least two bladderless tanks and first and second valves thereon, the polyurethane foam component therein, and the dispenser, is less than about 600 pounds, such that the system may be portably moved by a single person to a worksite.

4. The system according to claim 3, wherein the booster further includes a regulator for regulating the pressurized air at the high pressure outlet of the booster to provide an operating pressure range that is within 10 pounds per square inch and is adjustable between upper and lower limits of 160 and 200 pounds per square inch, whereby said adjustment enables control over the density and dispensing rate of polyurethane foam component to allow for various conditions.

5. The system according to claim 4, wherein the desired pressure level is preferably in the range of between about 170 and 190 pounds per square inch.

6. The system according to claim 4 wherein the second valve is positioned in each bladderless tank adjacent the bottom such that less than about 1% of the initial quantity of polyurethane foam component remains within the first and second bladderless tanks when the system fully dispenses the polyurethane foam components.

7. The system according to claim 6 wherein first valve is positioned above the second valve, and the first and second valves are both connected to each bladderless tank at a single location.

8. A DOT-39 compliant dispensing system for dispensing a polyurethane foam component under constant pressure, the system comprising:
a compressor having an outlet through which air is supplied;
a booster coupled to the outlet of the compressor, being configured to compress the air output from the compressor to a pressure of between about 160 and 200 pounds per square inch, the booster including a regulator for regulating the booster output to provide, via a high pressure outlet, a supply of pressurized air at an operating pressure range within 10 pounds per square inch that is adjustable between about 160 and about 200 pounds per square inch, to thereby enable control over the density and dispensing rate of polyurethane foam component to allow for various conditions;
a first bladderless tank and a second bladderless tank, each having an internal volume that is sized less than 1,526 cubic inches to comply with DOT-39 specifications for non-reusable, non-refillable cylinders, the first and second bladderless tanks having a quantity of a first polyurethane foam component and a second polyurethane foam component that is sufficient to fill at least 70 percent of the internal volume of the first and second bladderless tanks, respectively;
the first and second bladderless tanks each having a first valve connected to the high pressure outlet of the booster for communicating the pressurized air into the bladderless tank, and a second valve adjacent the bottom of the bladderless tank, for connecting to a hose associated with a dispenser;
a dispenser for dispensing the first and second polyurethane foam components from the first and second bladderless tanks, the dispenser being connected via a hose to the second valve adjacent the bottom of each of the first and second bladderless tanks so as to enable dispensing of substantially all of the first and second polyurethane foam component disposed within the first and second bladderless tanks, to minimize any remnant of polyurethane foam component left within the at least two bladderless tanks; and
wherein the compressor with the booster and regulator provide a continuously replenished source of pressurized air for pressurizing the first and second bladderless tanks to an adjustable pressure between about 160 and about 200 pounds per square inch, to thereby provide control over the density and dispensing rate of polyurethane foam and to enable substantially all of the first and second polyurethane foam component within the first and second bladderless tanks to be dispensed at constant pressure through the second valve adjacent the bottom of each of the first and second bladderless tanks.

9. The system according to claim 8, further comprising a cart on which the compressor, the booster, and the first and second bladderless tanks are disposed.

10. The system according to claim 9, wherein the combined weight of the cart, the compressor, the booster, the first and second bladderless tanks and first and second valves thereon, the first and second polyurethane foam components therein, and the dispenser, is less than about 600 pounds, such that the system may be portably moved by a single person to a worksite.

11. The system according to claim 8, wherein the desired pressure level is preferably in the range of between about 170 and about 190 pounds per square inch.

12. The system according to claim 10 wherein the second valve is positioned in each of the first and second bladderless tanks such that less than about 1% of the initial quantity of the first and second polyurethane foam components remain within the first and second bladderless tanks when the system fully dispenses the polyurethane foam components.

13. The system according to claim 12 wherein first valve is positioned above the second valve, and the first and second valves are both connected to the first and second bladderless tanks at a single location.

14. A method for the pressure dispensing of a polyurethane foam component material at a remote location, the method comprising:
filling first and second bladderless tanks having an internal volume that is sized less than 1,526 cubic inches to comply with DOT 39 specifications for non-refillable cylinders, with a quantity of a first polyurethane foam component and second polyurethane foam component that is sufficient to fill at least 70 percent of the internal volume of the first and second bladderless tanks respectively,
transporting the first and second bladderless tanks and quantity of first and second polyurethane foam components to a remote worksite location; generating a supply of compressed air at a pressure of between about 160 and 200 pounds per square inch, via a booster coupled to the outlet of a compressor, that is communicated to a first valve disposed in each of the first and second bladderless tanks to pressurize the first and second bladderless tanks;
connecting a dispenser via a hose to a second valve in each of the first and second bladderless tanks that is disposed adjacent the bottom of the bladderless tank; and
dispensing the first and second polyurethane foam components from the first and second bladderless tanks that are supplied with pressurized air such that the first and second polyurethane foam components are dispensed under constant pressure,
wherein the first and second polyurethane foam components are dispensed while the compressor and booster provide a continuously replenished supply of compressed air to pressurize the first and second bladderless tanks, to enable substantially all of the first and second polyurethane foam components within the first and second bladderless tanks to be dispensed at constant pressure through the second valve adjacent the bottom of each of the first and second bladderless tanks, to thereby minimize any remnant of polyurethane foam component left within the first and second bladderless tanks.

15. The method according to claim 14, further comprising the intermediate step of regulating the pressurized air that is communicated to the first valve to provide an operating pressure range within 10 pounds per square inch that is adjustable between about 160 and 200 pounds per square inch.

16. The method according to claim 15, further comprising the step of moving the compressor, the booster, the first and second bladderless tanks and first and second valves thereon, the first and second polyurethane foam components therein, and the dispenser to a desired location at a worksite.

17. The method according to claim 14 wherein the step of filling comprises filling the first and second bladderless tanks to at least about 90 percent of the internal volume of each of the first and second bladderless tanks.

18. The method according to claim 14 further comprising dispensing at least 99 per cent of the initial quantity of the first and second polyurethane foam components.

19. The method according to claim 15 wherein the density of the dispensed polyurethane foam at the start of dispensing and the density of the dispensed polyurethane foam at the completion of dispensing varies by no more than about 8 percent when no other system changes are imposed.

20. The method according to claim 15 wherein the dispensing rate at the start of dispensing and the dispensing rate at the completion of dispensing various by no more than about 15 percent when no other system changes are imposed.
